(19) United States
(12) Patent Application Publication
(10) Pub. No.: US 2010/0212776 A1
(43) Pub. Date: Aug. 26, 2010

(54) SELF CLEANING PILL COUNTING DEVICE, AND CLEANING METHOD

(75) Inventors: Brent Fay, Chester (CA); Michael Jarvis, Chester (CA)

Correspondence Address: BERESKIN AND PARR LLP/S.E.N.C.R.L., s.r.l., 40 KING STREET WEST, BOX 401, TORONTO, ON, M5H 3Y2, CA

(73) Assignee: CLEANCOUNT INCORPORATED, Chester (CA)

(21) Appl. No.: 12/680,820

(22) PCT Filed: Mar. 31, 2008
(86) PCT No.: PCT/CA2008/000604

§ 371 Date: Mar. 30, 2010

(30) Foreign Application Priority Data
Oct. 2, 2007 (CA) PCT/CA2007/001760

(51) Int. Cl. B65B 3/26; B08B 5/04

(52) U.S. Cl. 141/83; 134/21

(57) ABSTRACT

A pills counting device provided with cleaning means and comprising in combination, a tray comprising: a base member having an upper surface for receiving a bulk quantity of pills; a trough member alongside the base member and provided with a depression having opposite ends and at least one surface for receiving a load of a counted quantity of pills from said bulk quantity, one of said opposite ends further defining a spout for the unloading said counted quantity of pills in a pills container, a lid member having a lower surface, said lid member being mounted on the base member and being movable between two extreme positions, that is: a first position where the lower surface of the lid member is away from the upper surface of the base member and the surface of the depression of the trough member; a second position where the lower surface of the lid member is close and above the upper surface of the base member and the surface of the depression of the trough member to thereby creates a cavity; at least one port provided in the tray and/or in the lid member and adapted to be connected in fluid communication with the cavity and with an air intake of a vacuum device that can be remotely controlled; being understood that when the lid is in the second position and a vacuum is applied to said at least one port, an air stream is established between said surfaces to entrain toward the vacuum device particles that may be present on said surfaces to clean said surfaces. Optionally, the device can be further provided with at least one admission port for a pressurized gas that can be laden with frozen carbon dioxide particles. These particles are intended to blast surfaces of the cavity to be cleaned. A cleaning method using aforesaid pills counting device.

### TECHNICAL FIELD OF INVENTION

The present invention relates to a self cleaning pill counting device to prevent contamination from one medication to another. The invention also relates to a method for cleaning a pill counting device.

### BACKGROUND ART OF THE INVENTION

In hospital, nursing homes or pharmacies, batches of pills are counted on a pill tray. When different medications are counted on a same tray, the second or subsequent batch of pills could become contaminated with dust or heavier particles from the first batch, and so on. These contaminations could cause many inconveniences, such as, for example, allergic reactions in patients taking medication from the second or subsequent batch of pills.

Up to now, the only way to avoid contamination was to carefully wash the tray or to use a disposable tray. This is either time consuming and/or expensive.

Therefore, there is a strong need for a self cleaning pill counting device, and cleaning method thereof, that overcome the drawbacks of the prior art.

### SUMMARY OF THE INVENTION

According to a preferred and non restrictive embodiment, the present invention relates to a self cleaning pill counting device comprising in combination:
a tray comprising:
   a base member having an upper surface for receiving a bulk quantity of pills;
   a trough member alongside the base member and provided with a depression having opposite ends and at least one surface for receiving a load of a counted quantity of pills from the bulk quantity, one of the opposite ends further defining a spout for the unloading of the counted quantity of pills in a pills container,
a lid member having a lower surface, the lid member being mounted on the base member and being movable between two extreme positions, that is:
   a first position where the lower surface of the lid member is away from the upper surface of the base member and the surface of the depression of the trough member;
   a second position where the lower surface of the lid member is close and above the upper surface of the base member and the surface of the depression of the trough member to thereby creates a cavity;
at least one evacuation port provided in the tray and/or in the lid member and adapted to be connected in fluid communication with the cavity and with an air intake of a vacuum device that is remotely controlled;
   being understood that when the lid is in the second position and a vacuum is applied to at least one evacuation port, an air stream is established within the cavity to entrain toward the vacuum device dusts and/or particles that may be present is the cavity.

According to another preferred and non restrictive embodiment, the present invention relates to a device as described hereinabove, wherein the lower surface of the lid member is substantially mating above the upper surface of the base member and the surface of the depression of the trough member.

According to another preferred and non restrictive embodiment, the present invention relates to a device as described hereinabove, wherein the at least one evacuation port means one evacuation port provided across the lid member and in fluid communication with the cavity through the lower surface, or wherein the at least one evacuation port is provided across the base member and in fluid communication with a chamber that is itself in fluid communication with cavity, the chamber being at least defined by a portion of the base member, and at least a portion of the lid member.

According to another preferred and non restrictive embodiment, the present invention relates to a device as described hereinabove, wherein when the at least one evacuation port is one opening provided across the lid member and is in fluid communication with the cavity through the lower surface, at least a portion of the lower surface of the lid member defines a funnel of small height toward the opening.

According to another preferred non restrictive embodiment, the present invention relates to a device as described hereinabove, wherein when the at least one evacuation port is provided across the lid member and is in fluid communication with the cavity through the lower surface:
at least a portion of a periphery of the upper surface is adjacent a first wall member,
at least a portion of a periphery of the lower surface is adjacent a second wall member, and
the first wall member and the second wall member abut at least in part one against the other when the lid member is in the second position.

According to another preferred and non restrictive embodiment, the present invention relates to a device as described hereinabove, wherein when the at least one port is provided across the lid member and communicates with the cavity through the lower surface:
the first wall member forms a first rim around the upper surface of the base member and a periphery of the depression,
the second wall member forms a second rim around the lower surface of the lid member, and
the first rim and the second rim abut at least in part one against the other when the lid member is in the second position.

According to another preferred and non restrictive embodiment, the present invention relates to a device as described hereinabove, wherein when the at least one evacuation port is one opening provided across the base and in fluid communication with a chamber that is itself in fluid communication with the cavity, and the chamber is at least defined by a portion of the base member, and at least a portion of the lid member,
at least a portion of a periphery of the upper surface is adjacent a first wall member,
at least a portion of a periphery of the lower surface is adjacent a second wall member, and
the first wall member and the second wall member abut at least in part one against the other when the lid member is in the second position.

According to another preferred non restrictive embodiment, the present invention relates to a device as described hereinabove, wherein when the at least one evacuation port means is provided across the base and is in fluid communication with a chamber that is in fluid communication with the cavity, and the chamber is at least defined by a portion of the base member and at least a portion of the lid member,
the first wall member forms a first rim around the upper surface of the base member and a periphery of the depression,
the second wall member forms a second rim around the lower surface of the lid member, and
the first rim and the second rim abut at least in part one against the other when the lid member is in the second position.

According to another preferred non restrictive embodiment, the present invention relates to a device as described hereinabove, wherein when the at least one evacuation port is provided across the base and is in fluid communication with a chamber that is itself in fluid communication with the cavity, and the chamber is at least defined by a portion of the base member and at least a portion of the lid member, the first rim and the second rim along with the base member and the lid member define walls of the chamber.

According to another preferred and non restrictive embodiment, the present invention relates to a device as described hereinabove, wherein the lid member is pivotally mounted on the base member.

According to another preferred and non restrictive embodiment, the present invention relates to a device as described hereinabove, wherein the trough member has at least a portion thereof that is pivotally mounted on the base member, the portion being provided with the at least one surface of the depression and the spout.

According to another preferred and non restrictive embodiment, the present invention relates to a device as described hereinabove, wherein the portion of the through pivots between two extreme positions, that is a first position where the at least one surface of the depression is substantially parallel with the upper surface of the base member, and a second position where the at least one surface of the depression is inclined to have the spout moves downwardly.

According to another preferred and non restrictive embodiment, the present invention relates to a device as described hereinabove, wherein the vacuum device is incorporated to the base.

According to another preferred and non restrictive embodiment, the present invention relates to a device as described hereinabove, wherein a filtering means is provided between the at least one evacuation port and the vacuum device.

According to another preferred and non restrictive embodiment, the present invention relates to a device as described hereinabove, wherein an on/off switch device is further provided and more preferably mechanically connected to the base member and the lid member to remotely start/stop the vacuum device when the lid member is moved from one extreme position to another extreme position.

According to another preferred and non restrictive embodiment, the present invention is further provided with at least one additional port defining an admission port for the admission of a pressurized gas in the cavity. The admission port may be provided in the base member, in the lid member or at once in the base member and the lid member. More preferably, the admission port is provided in the lid member. Any inert gas can be used. An inert gas is any gas that does not chemically react under cleaning conditions, with the device or products that may be normally present on the surfaces. Advantageously, as non restrictive examples, inert gas may consist of carbon dioxide, dry air or mixtures thereof.

According to another preferred and non restrictive embodiment of the invention, the admission port may be further provided with a portion defining a manifold having at least one nozzle in fluid communication with the cavity and oriented toward portions of surfaces to be cleaned. A plurality of nozzles can also be provided. Optionally, this manifold portion is provided in the lid member. Also, advantageously and non restrictively, nozzles may be distributed according to a grid pattern.

According to another preferred and non restrictive embodiment of the invention, the pressurized inert gas is further laden with particles (solid or liquid, preferably solid) intended to blast surfaces of the cavity to be cleaned, the particles being made of a material that sublime after having contacted the surfaces. Any particles of sublimable material that may blast surfaces and then sublime under cleaning conditions can be used. Non restrictive examples of sublimable material can be frozen carbon dioxide or liquid nitrogen. The pressurized gas as well as the gas generated from the sublimable materials and any other dust particles or debris dislodged or removed from the surfaces to be cleaned, are then evacuated by the vacuum means through the evacuation port(s

According to another preferred and non restrictive embodiment of the invention, particles intended to blast surfaces of the cavity to be cleaned and then sublime after having contacted the surfaces, are made advantageously and non restrictively of frozen carbon dioxide (also called dry ice). Indeed, from an economical point of view, use of particules of frozen carbon dioxide is preferred because of its low costs, its availability and the generation of gaseous carbon dioxide that do not leave residue on the cleaned surfaces. Advantageously and without any restriction, particles of frozen carbon dioxide may consist of dry ice pellets that are available on the market or easily manufactured with existing devices well known to skilled workman.

Also, any appropriate means well known to skilled workman to admix particles of frozen carbon dioxide in a stream of pressurized gas can be used.

According to a further particularly preferred and non restrictive embodiment, the source of pressurized gas laden with particles of frozen carbon dioxide may comprise a device available on the market, such as for example a device sold under the trademark SNOWGUN® by the company VA-TRAN.

According to a further particularly preferred and non restrictive embodiment, the admission port for the pressurized gas that may be eventually laden with particles of sublimable materials (more preferably of particles of frozen carbon dioxide) may be further provided with a portion defining a manifold having a plurality of nozzles oriented toward various portions of surfaces of the cavity to be cleaned. Optionally nozzles are provided in the lid member and advantageously and non-restrictively distributed according to a grid pattern.

According to another preferred and non restrictive embodiment, the present invention relates to a method for cleaning at least one surface of a counting pill. The method comprises contacting particles present on said surface with at least one jet of a sublimable material and removing said material and said particles from said at least one surface by means of a vacuum. For example, the particles can comprise dust or debris of pill. The at least one jet can comprise solid CO₂ particles, the solid CO₂ particles being contacted with said dust or debris of pill so as to abrade them, and then, said solid CO₂ particles are sublimated and CO₂ is vacuumed together with dust or debris of pill. The jet comprising solid CO₂ particles can be obtained from a mixture of a pressurized gas and solid CO₂ particles or from pressurized liquid CO₂ particles that are solidified.

According to another preferred and non restrictive embodiment, the present invention relates to a method for cleaning a counting pill device. The device can be, in a non restrictive manner a device as defined hereinbefore in which a vacuum is applied by the vacuum device to the cavity to create an air stream than entrain dust and/or particles that may be present in the cavity. Optionally, the air stream may be increased by admitting within the cavity of a pressurized gas. Optionally, the pressurized inert gas can be further laden with particles intended to blast surfaces of the cavity to be cleaned, the particles being made of a material that sublime after having contacted the surfaces.

According to another preferred and non restrictive embodiment, the present invention relates to a method for cleaning a device as defined hereinbefore, wherein a vacuum is applied by the vacuum device to the air contained in the cavity to thereby create an air stream in the cavity than entrain any particles that may be present in the cavity.

According to another preferred and non restrictive embodiment, the present invention relates to a method for cleaning a device as defined hereinbefore, wherein simultaneously with the vacuum applied by the vacuum device, a pressurized gas is introduced in the cavity through at least one admission port which can be provided in the lid member and/or in the base member and in fluid communication with the cavity. More preferably, the pressurized inert gas can be further laden with particles intended to blast surfaces of the cavity to be cleaned, the particles being made of a material that sublime after having contacted the surfaces.

According to another preferred and non restrictive embodiment, the method involves an admission port that is further provided with a nozzle to create a gas jet oriented toward at least one of the surfaces delimiting the cavity.

According to another preferred and non restrictive embodiment, the method involves an admission port having a manifold portion provided with a plurality of nozzles in fluid communication with the cavity and oriented to create gas jets toward portions of surfaces of the cavity to be cleaned. According to to another preferred and non restrictive embodiment, the device further comprises at least one admission port introducing in the cavity a pressurized gas laden with solid particles, liquid particles, or a mixture thereof The admission port can also be used for introducing a pressurized liquid or a pressurized liquid laden with solid particles

According to another preferred and non restrictive embodiment of the device, the transmission port is further provided with a manifold portion that is in fluid communication with a plurality of nozzles, the nozzles being in fluid communication with the cavity and oriented to direct jets of the pressurized gas laden with solid particles, liquid particles, or a mixture thereof, or jets of a pressurized liquid or a pressurized liquid laden with solid particles against surfaces of the cavity. Alternatively, the manifold can be in fluid flow communication with at least one nozzle.

According to another preferred and non restrictive embodiment the device, the pressurized gas laden with solid particles, liquid particles, or a mixture thereof is obtained from a pressurized liquid that is expanded at outlet(s) of nozzle(s) to form jet(s) comprising a mixture of pressurized gas with solid particles or with solid particles and liquid particles, the solid particles being projected against surfaces of the cavity to blast them.

According to another preferred and non restrictive embodiment of the device, the pressurized liquid once expanded will form an inert gas under cleaning operation in the cavity, solid particles will sublime into gas after having contacted surfaces to be cleaned and eventual liquid particles will evaporate into gas under cleaning operation.

According to another preferred and non restrictive embodiment of the device, the pressurized liquid is pressurized liquid CO₂, the pressurized gas is gaseous CO₂, solid particles are frozen CO₂ and liquid particles are liquid CO₂.

According to another preferred and non restrictive embodiment of the device, the manifold is housed in the lid member and nozzles are provided in the lower surface of the lid member.

According to another preferred and non restrictive embodiment of the device, nozzles are uniformly distributed in the lower surface of the lid member.

According to another preferred and non restrictive embodiment of the device, a conduit, such as a capillary tube, puts each nozzle in fluid communication with the manifold.

According to another preferred and non restrictive embodiment, the method defined hereinabove further comprises a step according to which simultaneously with the vacuum applied by the vacuum device, a pressurized gas laden with solid particles or with solid particles and liquid particles, is introduced in the cavity through at least one admission port provided in the lid member and/or in the base member and in fluid communication with the cavity.

According to another preferred and non restrictive embodiment of the method, the admission port is further provided with a manifold portion that is in fluid communication with a plurality of nozzles, the nozzles being in fluid communication with the cavity and oriented to direct jets of the pressurized gas laden with solid particles or with solid particles and liquid particles, against surfaces of the cavity.

According to another preferred and non restrictive embodiment of the method, the pressurized gas laden with solid particles or with solid particles and liquid particles, is obtained from a pressurized liquid that is expanded at outlets of nozzles to form jets comprising a mixture of pressurized gas with solid particles or with solid particles and liquid particles, the solid particles being projected against surfaces of the cavity to blast them.

According to another preferred and non restrictive embodiment of the method, the pressurized liquid is pressurized liquid CO₂, the pressurized gas is gaseous CO₂, solid particles are frozen CO₂ and liquid particles are liquid CO₂.

According to another preferred and non restrictive embodiment of the method, the pressurized liquid is pressurized liquid CO₂, the pressurized gas is gaseous CO₂, solid particles are frozen CO₂ and liquid particles are liquid CO₂.

According to another preferred and non restrictive embodiment of the method, the manifold is housed in the lid member and nozzles are provided in the lower surface of the lid member.

According to another preferred and non restrictive embodiment of the method, nozzles are uniformly distributed in the lower surface of the lid member.

According to another preferred and non restrictive embodiment of the method, a conduit, such as a capillary tube, puts each nozzle in fluid communication with the manifold.

### BRIEF DESCRIPTION OF DRAWINGS

The present invention will be better understood with reference to the enclosed drawings illustrating particularly preferred and non restrictive aspects of the invention. More particularly, the drawings comprise the following figures:

FIG. 1 is a schematic view of a pill counting device according to the invention with a vacuum device and in dotted lines a variant thereof where a pressurized gas is further used simultaneously with the vacuum device.

FIG. 2 is a side elevation view of a pill counting device according to a first particularly preferred embodiment invention.

FIG. 3 is a perspective view of the pill counting device of FIG. 2 (with the trough inclined).

FIG. 3a is an illustration of a filter in a cartridge shown in FIG. 3.

FIG. 4 is a perspective view of the pill counting device of FIG. 3.

FIG. 5 is a top plane view of the base member and trough member.

FIG. 6 is a cross sectional view of the portion of the lid according to line VI-VI in FIG. 3.

FIG. 7 is cross sectional view according to line VII-VII in FIG. 2 with the lid member in close position.

FIG. 8 is a perspective view of a pill counting device according to a second particularly preferred embodiment of the invention.

FIG. 9 is a partial cross sectional view of the pill counting device of FIG. 8 showing details of the chamber.

FIG. 10 is a schematic view of a pill counting device according to a third particularly preferred embodiment of the invention with a vacuum device and in dotted lines a variant thereof where a pressurized gas and particles of frozen carbon dioxide are further used simultaneously with the vacuum device

FIG. 11 is a perspective view of the pill counting device of FIG. 3 further provided, according to a third particularly preferred embodiment of the invention, with means for the admission of pressurized gas eventually laden with abrading particles of dry ice, and showing details of the underneath of the lid.

FIG. 12 is a perspective view of the pill counting device of FIG. 11 showing details of the top of the lid.

### DESCRIPTION OF BEST MODES FOR CARRYING OUT PARTICULARLY PREFERRED EMBODIMENTS OF THE INVENTION

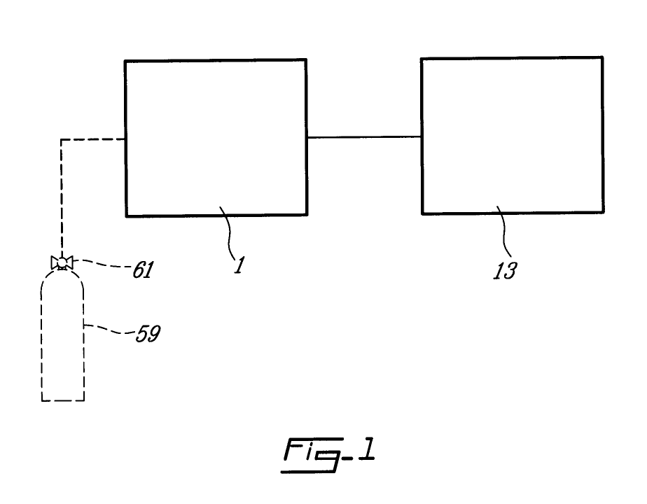

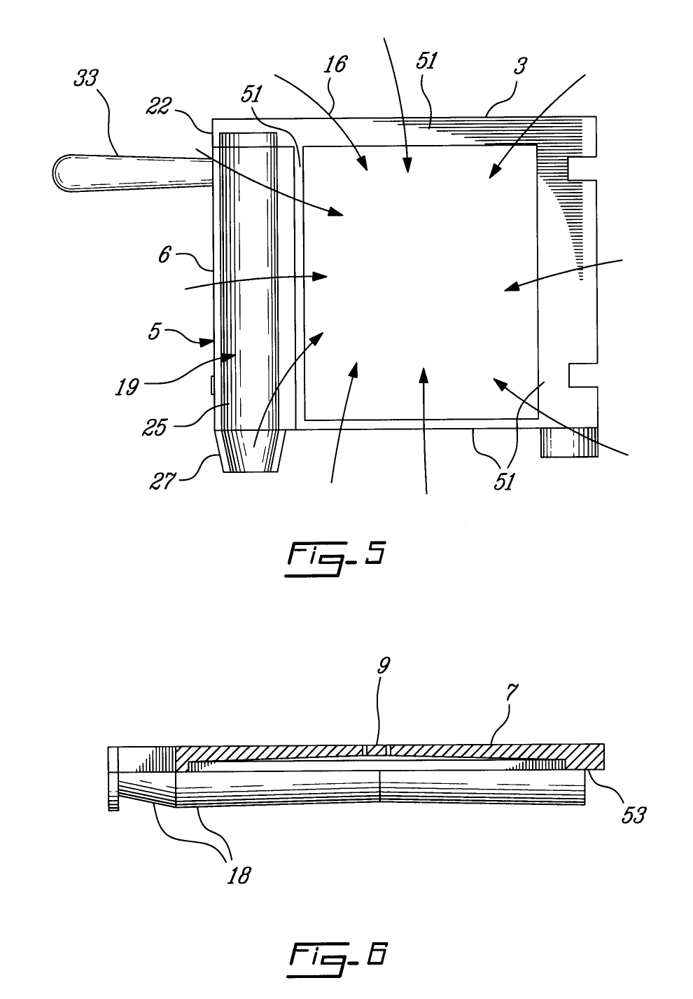

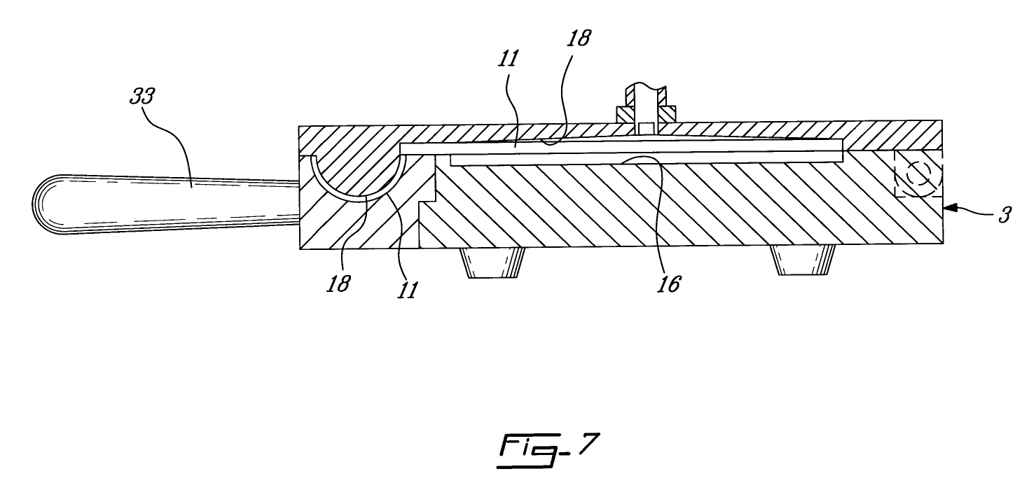

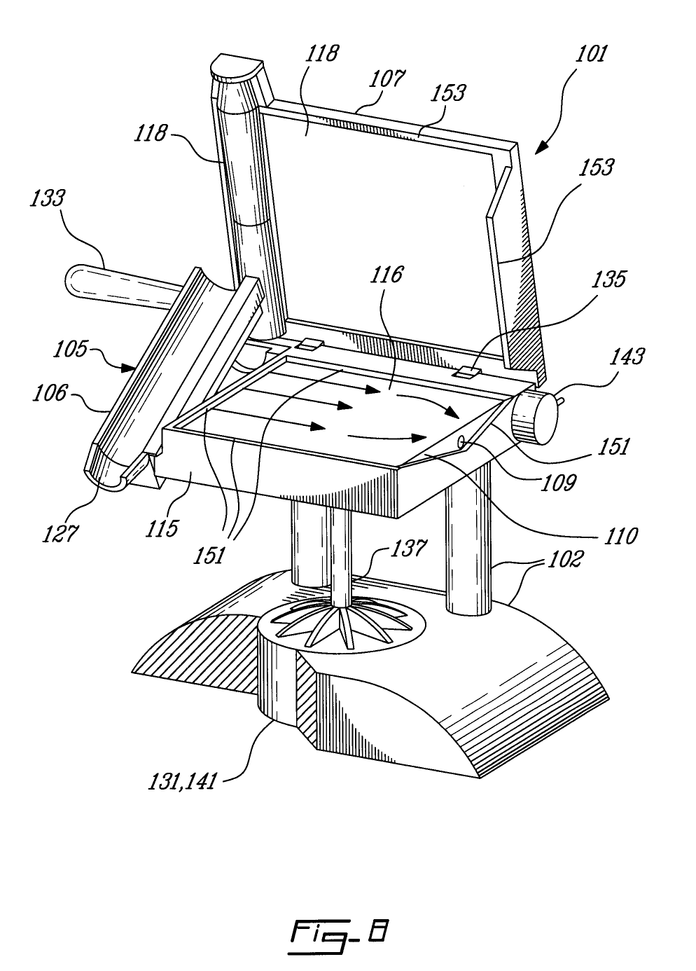

According to a first particularly preferred and non restrictive embodiment of the invention, there is described with reference to FIGS. 1 to 7 of the drawings, a self cleaning pill counting device 1. This device 1 comprises in combination a tray 3, a trough member 5, a lid member 7 and at least one evacuation port such as an opening 9 as illustrated, provided in the lid member 7 and adapted to be connected in fluid communication with a cavity 11 and with an air intake of a vacuum device 13 that is remotely controlled. When the lid member 7 is in closed position (i.e. at the second position) and a vacuum is applied to the at least one port 9, an air stream is established in the cavity 11 to entrain toward the vacuum device 13 dusts and/or particles that may be present in the cavity 11.

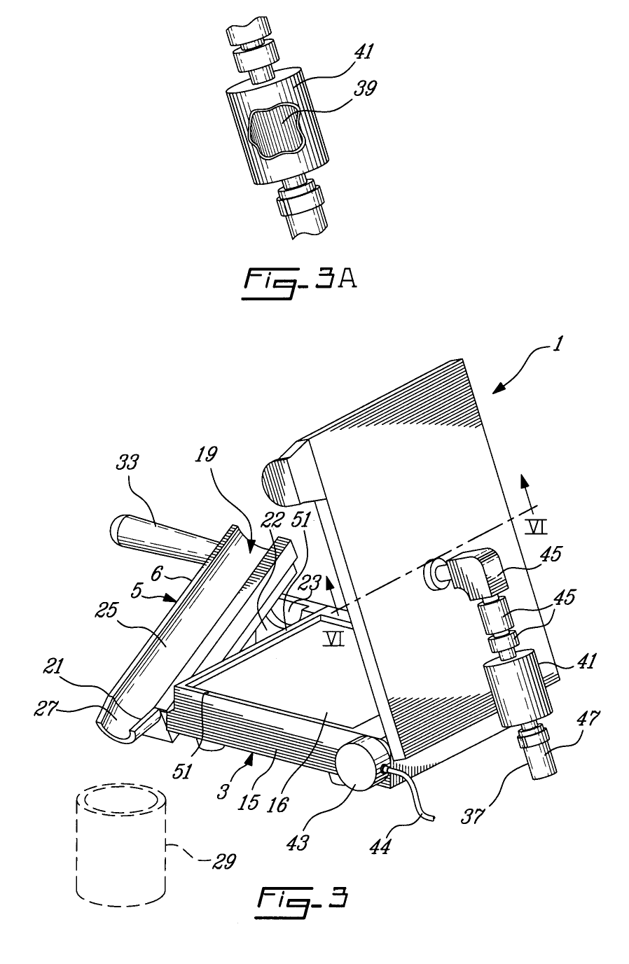

More particularly, the tray 3 comprises a base member 15 having an upper surface 16 for receiving a bulk quantity of pills; a trough member 5 alongside the base member 15 and provided with a depression 19 having opposite ends 21, 23 and at least one surface 25 for receiving a load of a counted quantity of pills from the bulk quantity. The end 21 further defines a spout 27 for the unloading the counted quantity of pills in a pills container 29 (shown in dotted lines in FIG. 3). The trough member 5 has a portion 6 that is pivotally mounted to the base member 15 on a pivot 31 and is optionally provided, as illustrated, with a handle 33. A remaining portion 22 of the trough member 5 makes an integral part of the base member 15 and comprises the end 23.

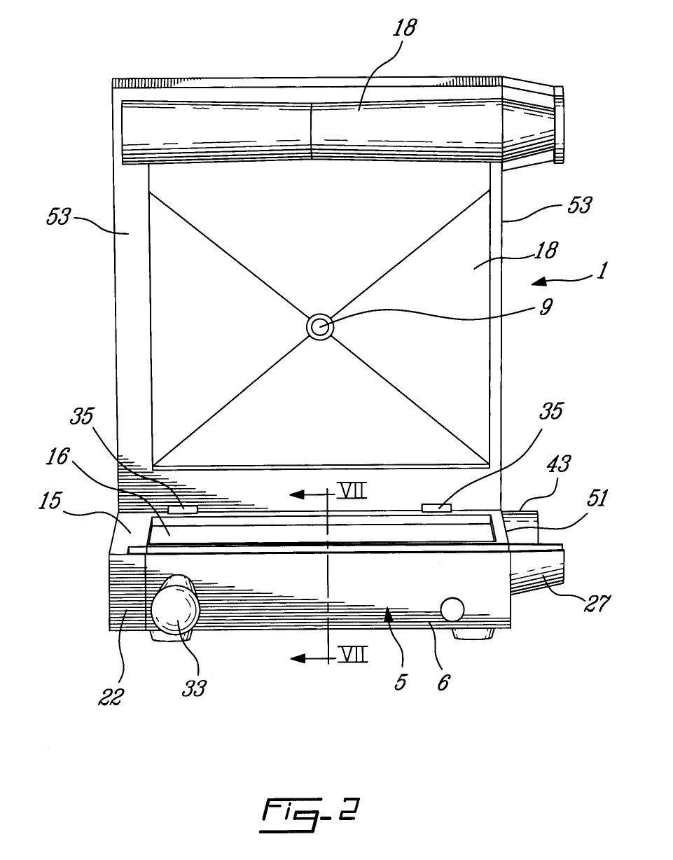

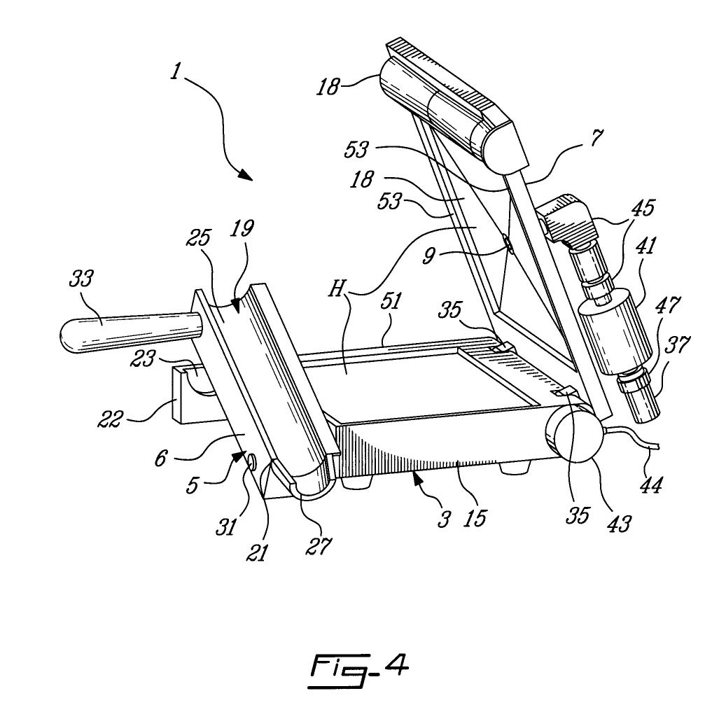

The trough member 5 can be moved between two extreme positions, that is:
a first position (see FIG. 2) where the lid member 7 is away from the upper surface 16 of the base member 15 and the surface 25 of the depression 19 of the trough member 5; and
a second position (see FIG. 4) where a lower surface 18 of the lid member 7 is close and above the upper surface 16 of the base member 15 and the surface 25 of the depression 19 of the trough member 5 to thereby create a cavity 11.

The lid member 7 has a lower surface 18 and is mounted on the base member 15 around hinges 35 to be movable between two extreme positions, that is:
a first position where the lower surface 18 of the lid member 7 is away from the upper surface 16 of the base member 15 and the surface 25 of the depression 19 of the trough member 5; and
a second position where the lower surface 18 of the lid member 7 is close and above the upper surface 16 of the base member 15 and the surface 25 of the depression 19 of the trough member 5 to thereby create a cavity 11.
   When the lid member 7 is in the second position and a vacuum is applied to the opening 9, an air stream is established in the cavity 11 (see arrows) to entrain toward the vacuum device 13 dusts and/or particles that may be present in the cavity 11.

Also, even though any appropriate means can be used to connect the at least one evacuation port with an inlet port of the vacuum device, preferably the opening 9, as illustrated in FIGS. 1 to 7, is connected to an inlet port of the vacuum device 13 with a vacuum hose 37. This vacuum device may be of any common type. Preferably, the vacuum device is operated by an electric motor. Also, preferably as illustrated, a filter 39 is advantageously provided across the hose 37 for collecting air borne particle that are entrained form the cavity 11. The filter 39 may advantageously consists of a cartridge 41 that is mounted across the hose 37. The mounting of the cartridge can be made by any appropriate means, preferably conventional connectors. Similarly, the connection of the hose 37 to the opening 9 and the air intake of the vacuum device 13 can be made by any appropriate means, preferably with conventional connectors. The connectors can be made of any appropriated materials, such as plastic or metal tubing

As illustrated in FIGS. 1 to 7, the vacuum device 13 is remotely operated by a on/off rotary switch 43 mounted at the hinge portion of a base member 15 and lid member 7. When the lid member 7 is in the first position (i.e. away from the base member 15), the switch 43 is <<off>> and stops the vacuum device 13. When the lid member 7 is in the second position, the switch 43 is <<on>> and starts the vacuum device 13. As illustrated, the switch 43 and the electric motor of the vacuum device may be connected with an electric cord 44. Of course this electric cord is only illustrative and can be replace by any appropriate means well known to skilled workman. Alternatively, the on/off rotary switch 43 may be replaced and/or combined with a timer device in order to run the vacuum device for a determined period of time, or with any other appropriate device well known to skilled workman to control the operation of a vacuum device.

The cavity 11 which is positioned between the lower surface 18, which is preferably shaped as a funnel toward the opening 9 as illustrated, the surface 25 and the upper surface 16, and has its height adjusted with the capacity of the vacuum device 13. Preferably, as illustrated, the cavity is further delimited by rims 51 and 53. The rims abut one against the other to fix the height of the cavity 11. This height may preferably vary from few millimeters to few centimeters. When the vacuum device 13 has a low capacity, the height will be smaller and when the vacuum device 13 has a high capacity the height will be greater. It is just necessary to create a stream of air within the cavity 11 to entrain dusts and/or particles that may be present in the cavity 11 toward the vacuum device 13 and preferably, as illustrated against the filter 39 where dusts and/or particles are collected. Of course this filter 39 may be easily detachable from the vacuum hose 37 and can be replaced easily. As illustrated, fittings 45, 47 can be provided. Of course, any other appropriate means allowing easy removal of the filter 39 can be used. The used filters 39 can be discarded in bio-hazardous waste.

Material use to embody the device according to the invention may be of any kind. Preferably, metal or plastic material can be used. An example of metal can be aluminum of stainless steel while an example of plastic material may be polyethylene, etc.

In order to use a device 1 as defined hereinabove, the lid member 7 is moved away from the base member 15, the rotary switch is moved to a off position to stop the vacuum device if it was still running, and a bulk amount of pills in poured from a bulk container on the upper surface 16 of the base member 15, and then pills are manually counted and drop in the depression 19 as with conventional pill trays. Then the portion 6 of the trough member 5 is pivoted around its pivot 31 to pour the counted quantity in the pill container 29. Thereafter, the remainder of the bulk amount of pills are removed from the upper surface and returned in the bulk container.

Optionally, as illustrated in FIG. 1, the self cleaning device 1 may be further provide with at least one admission port (preferably one or several openings) connected to a source of a pressurized gas, and in fluid communication with the cavity. More particularly, the admission port(s) (preferably opening(s)) may comprise nozzles to create and direct one or several air jets against one or several surfaces delimiting the cavity 11. The admission port may be provided in the lid member 7 and/or in the base member 15, more preferably in the lid member 7.

The pressurized gas may consist of carbon dioxide, dry air or mixtures thereof. The pressurized gas may be obtained from a pressurized container 59 (as illustrated in FIG. 1), a compressor or any other source of pressurized gas. Advantageously, the at least one admission port for the pressurized gas and the at least one port for the vacuum are at opposite ends of the cavity.

Advantageously, as illustrated in dotted lines in FIG. 1, the source of pressurized gas may be connected to the at least one admission port with conventional tubings and fittings well known to skilled workman. The control of the pressurized gas may be obtained with valves 61 also well known to skilled workman. Alternatively, this valve may be controlled by a solenoid optionally activated by the rotary switch 43.

Thereafter, the lid member 7 is moved toward its second position around the hinges, the rotary switch is moved to a <<on>> position to activate a vacuum device that will create a vacuum in cavity 11 to entrain dusts and/or particles toward the filter 39.

Thereafter, generally after a determined period of time, the lid member 7 is moved away from the upper surface 16 and surface 25, the rotary switch is returned to the <<off>> position to stops the vacuum device and the device 1 can be used again. If necessary, after a visual check of the surfaces, the above operation can be repeated if there is still some traces of dusts and/or particles.

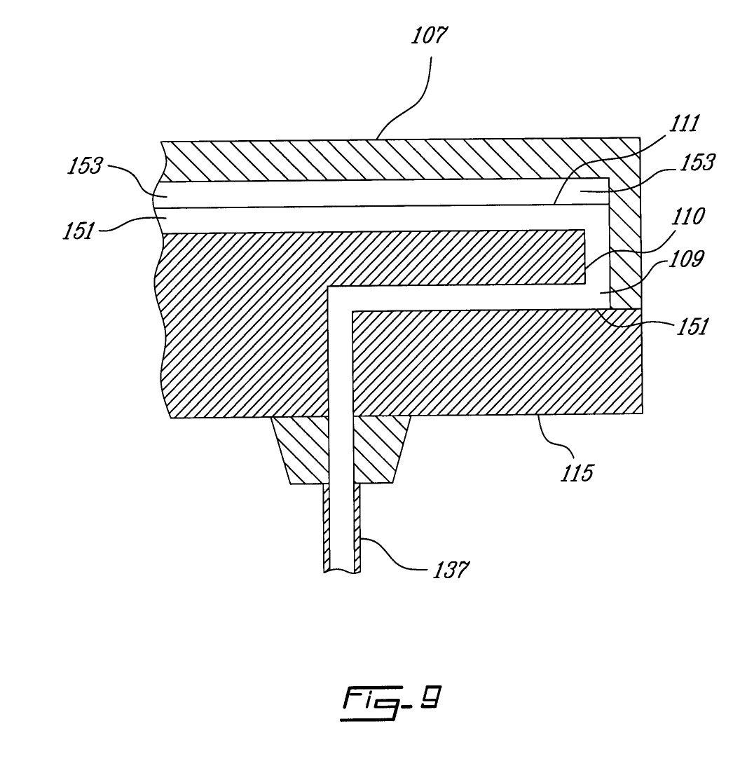

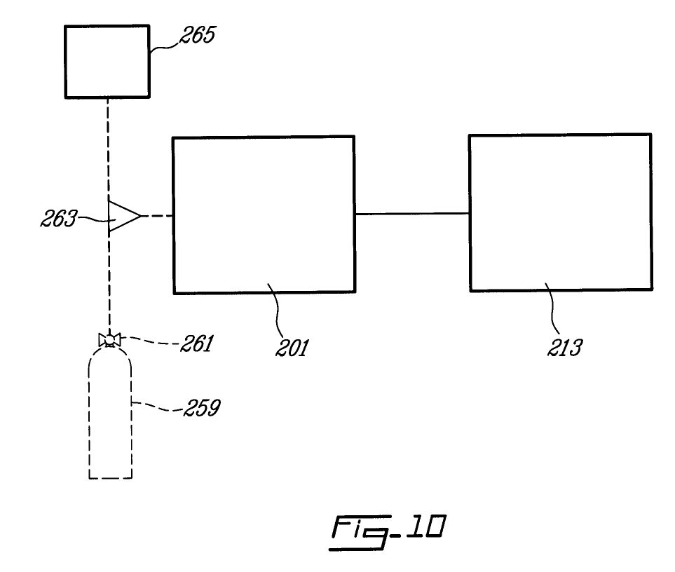

FIGS. 8 and 9 of the drawings illustrate a second preferred and non restrictive embodiment of the invention. The self cleaning pill counting device 101 is similar to the device 1 except that the at least one evacuation port is defined by the opening 109, is provided across the base member 15 and communicates with a chamber 110 that is in fluid communication with the cavity 111. The chamber 110 is defined by a portion of the base member 115 and a portion of the lid member 117. Also, the device 101 has the vacuum device 131 and/or the filter 141 integrated in a pedestal 102 supporting the device 101. When only the filter 141 is incorporated in the pedestal, the vacuum device 131 may be connected to the filter with conventional tubings and fittings. Remaining parts of the device 101 are similar to those of device 1 and operation of the device 101 is similar except for the flow of the air stream (see arrows). Parts similar to those of the device 1 are merely incremented by 100 in the device 101.

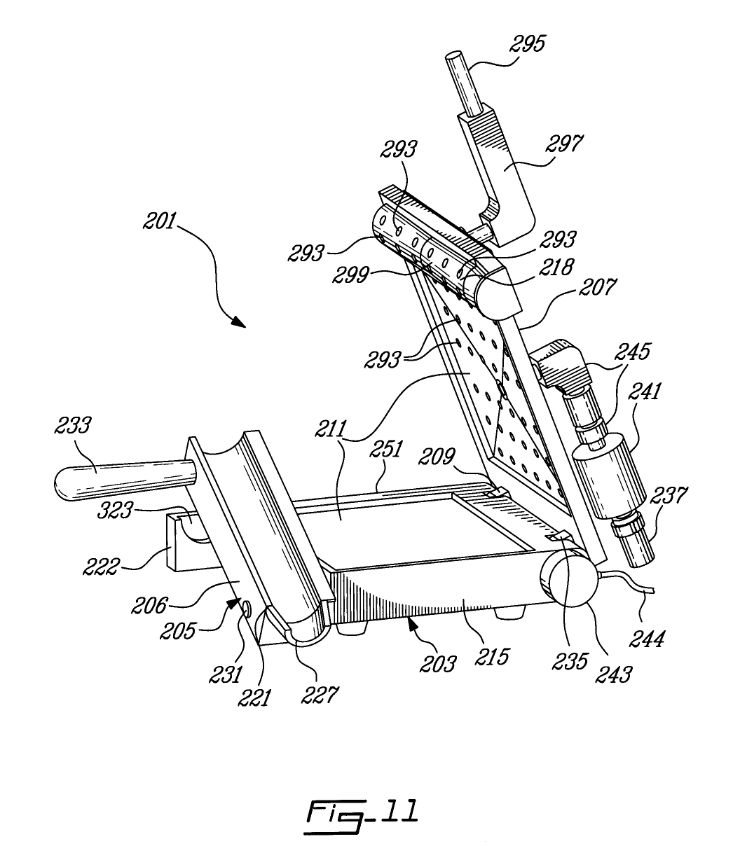

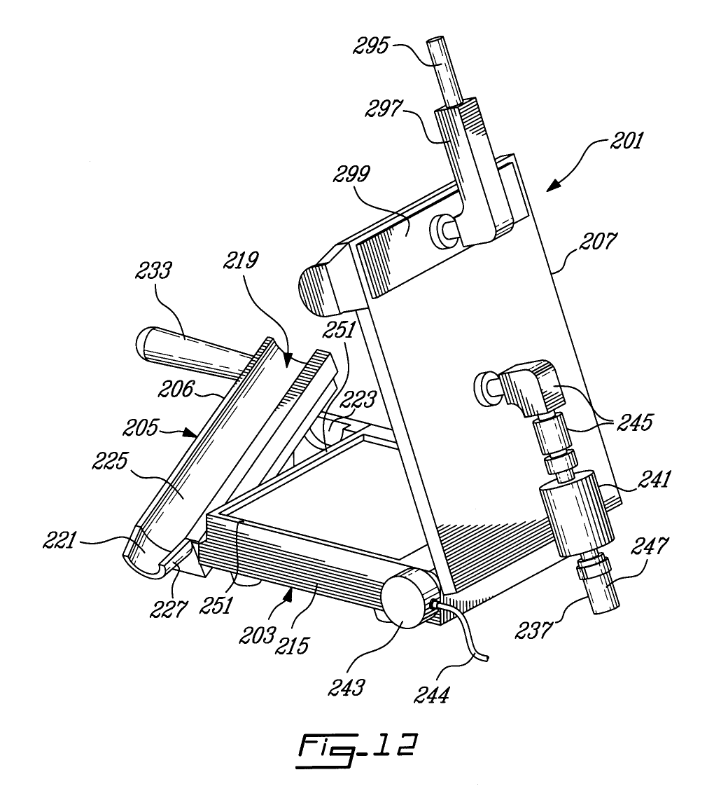

FIGS. 10 to 12 of the drawings illustrate a third preferred and non restrictive embodiment of the invention. The cleaning pill counting device 201 is similar to the device 1 except it is further provided with an admission port that is provided with a portion defining a manifold 299 having nozzle 293. Optionally as illustrated, nozzles 293 are distributed in the under surface 218 of the lid member 217 according to a grid pattern. The admission port can be connected to a source of a pressurized inert gas laden with particles of abrasive material (more preferably frozen carbon dioxide pellets). The abrasive material is intended to abrade surfaces to be cleaned and then sublime under operating cleaning conditions.

The pressurized inert gas eventually laden with the abrasive material is fed to the admission port with a conventional hose or tubing 295 well known to skilled workman. One end of the hose or tubing 295 is connected with standard fittings to the outlet of a known device 259 that generate pressurized gas or to the outlet of a known device 263 admixing the abrasive particles of sublimable materials (contained in a capacity 265) to the pressurized gas. The other end of the hose or tubing 295 is connected to the admission port with standard fittings 297 well known to the skilled workman.

According to a particularly preferred and non restrictive embodiment of the invention, solid and eventually liquid particles of CO₂ are generated <<in situ>> in the cavity 211. To do so, the admission port is fed with pressurized liquid CO₂ which in such case is contained in the cylinder 259. When the cylinder 259 is filled with pressurized liquid CO₂ device 263 and capacity 265 can be omitted in FIG. 10. They can also be present when a mixture comprising liquid CO₂ and solid CO₂ is provided to the admission port. Liquid CO₂ can be solidified when passing through a conduit (such as a capillary tube) which connect the manifold to the nozzles.

More particularly, when pressurized liquid carbon dioxide is used, each nozzle 293 is put in fluid communication with the manifold 299 with a conduit, such as a capillary tube (not illustrated). As an example the pressure in the cylinder 259 may be of 800 psi or more. When the pressurized liquid carbon dioxide expands at the outlet of a nozzle, a jet of gaseous carbon dioxide comprising solid particle of frozen carbon dioxide and eventually liquid carbon dioxide is projected against surfaces of the cavity to be cleaned. Impact of solid particles and eventually liquid particles, contribute to contact surfaces of the cavity 211 to remove any dust, particles or debris that may be present thereon, before being evacuated via the port 209. After contact with the surfaces, solid particles and eventually liquid particles are transformed in to gaseous carbon dioxide. Advantageously and non-restrictively, each nozzle is connected to a capillary tube of about 0.005 to about 0.007 inch. When liquid and/or gaseous CO₂ particles go through the capillary tube, they solidify so as to obtain the solid CO₂ particles. Solid particles of carbon dioxide are very small and the mechanical interaction of the particles of carbon dioxide with dust, particles or debris that may be present on the surface of the cavity dislodge the dust, particles or debris from the surfaces. In the methods and devices of the present invention the solid CO₂ particles can be generated from liquid and/or gaseous CO₂ by using a cooling device such as a Pelletier cooler.

Use of device 201 is similar to the one of device 1, except a pressurized gas preferably laden with the abrasive particles is further fed to the cavity 211. This pressurized gas is obtained from a pressurized liquefied gas (such as liquefied carbon dioxide) that is fed to the admission port, manifold 299, conduits (not illustrated) and nozzles 293) while the vacuum means is in operation. When the pressurized liquefied carbon dioxide is expelled from the nozzles 293, the stream of liquefied carbon dioxide is expanded and transformed <<in situ>> in the cavity 211 into a jet of pressurized carbon dioxide containing solid particles of frozen carbon dioxide and eventually particles of liquid carbon dioxide. Particles of carbon dioxide (which define the abrasive particles) are projected against surfaces of the cavity 211 to abrade its surfaces and dislodge or remove eventual dust and/or particles that may contaminate the surfaces. Abrasive particles also sublime into a gas and all remaining particles, dust and gas are evacuated through evacuation port 209 by the vacuum means.

While the invention has been described in connection with specific embodiments thereof, it will be understood that it is capable of further modifications and this application is intended to cover any variations, uses, or adaptations of the invention following, in general, the principles of the invention and including such departures from the present disclosures as come within known or customary practice within the art to which the invention pertains and as may be applied to the essential features herein before set forth, and as follows in the scope of the appended claims.

1. A self cleaning pill counting device comprising in combination:
a tray comprising:
a base member having an upper surface for receiving a bulk quantity of pills;
a trough member alongside the base member and provided with a depression having opposite ends and at least one surface for receiving a load of a counted quantity of pills from the bulk quantity, one of the opposite ends further defining a spout for the unloading of the counted quantity of pills in a pill container,
a lid member having a lower surface, the lid member being mounted on the base member and being movable between two extreme positions, that is:
a first position where the lower surface of the lid member is away from the upper surface of the base member and the surface of the depression of the trough member;
a second position where the lower surface of the lid member is close and above the upper surface of the base member and the surface of the depression of the trough member to thereby creates a cavity;
at least one evacuation port provided in the tray and/or in the lid member and adapted to be connected in fluid communication with the cavity and with an air intake of a vacuum device that is remotely controlled; and
at least one admission port for introducing in the cavity at least one jet comprising a solid material, a liquid material, or a mixture thereof;
being understood that when the lid member is in the second position and a vacuum is applied to the at least one evacuation port, an air stream is established within the cavity to entrain toward the vacuum device dusts and/or particles that may be present in the cavity.

2. A device according to claim 1, wherein the lower surface of the lid member is substantially mating above the upper surface of the base and the surface of the depression of the trough member.

3. A device according to claim 1, wherein the at least one evacuation port is provided across the lid member and communicates with the cavity through the lower surface.

4-6. (canceled)

7. A device according to claim 3, wherein the lid member is mounted on the base member.

8. A device according to claim 3, wherein the trough member has at least a portion thereof that is mounted on the base member, said portion being provided with said at least one surface of the depression and the spout.

9. A device according to claim 8, wherein the portion of the through can move between two extreme positions: a first position where the at least one surface of the depression is substantially parallel with the upper surface of the base member, and a second position where the at least one surface of the depression is inclined to have the spout moves downwardly.

10. A device according to claim 1, wherein the at least one evacuation port is provided across the base and communicates with a chamber that is in fluid communication with cavity, the chamber being at least defined by a portion of the base member and at least a portion of the lid member.

11-17. (canceled)

18. A device according to claim 10, wherein the vacuum device is incorporated to the base.

19-21. (canceled)

22. A device according to claim 1, wherein the at least one admission port is provided with a nozzle for directing the at least one jet toward at least one of the surfaces.

23. A device according to claim 1, wherein the at least one admission port has a manifold portion provided with a plurality of nozzles in fluid communication with the cavity for directing a plurality of jets toward at least one of the surfaces.

24. (canceled)

25. A device according to claim 61, wherein the gas jet comprises particles of the solid material and is intended to blast at least one of the surfaces, the solid material being a sublimable material that sublimes after having contacted the at least one surfaces.

26. (canceled)

27. A method for cleaning a device as defined in claim 1, the method comprising vacuuming said cavity by means of the vacuum device so as to entrain the content of the cavity whereby entraining particles that may be present in said cavity.

28. A method for cleaning a device as defined in claim 1, comprising introducing in the cavity at least one jet comprising a solid material, a liquid material, or a mixture thereof; and vacuuming the cavity by means of the vacuum device so as to entrain the content of the cavity.

29-40. (canceled)

41. A device according to claim 23, wherein the manifold is housed in the lid member and nozzles are provided in the lower surface of the lid member.

42-54. (canceled)

55. A method for cleaning at least one surface of a pill counting device, the method comprising:
contacting particles present on the at least one surface with at least one gas jet comprising a solid material, a liquid material, or a mixture thereof; and
removing the particles from the at least one surface of the pill counting device, the solid material, liquid material, or the mixture thereof and said gas by means of a vacuum.

56. A method according to claim 55, wherein said particles present on said at least one surface comprise dust or debris of pill.

57. A method according to claim 56, wherein the at least one gas jet comprises solid carbon dioxide particles, the solid carbon dioxide particles being contacted with the dust or debris of pill so as to abrade them, and then, the solid carbon dioxide particles are sublimated and carbon dioxide is vacuumed together with dust or debris of pill.

58. A method according to claim 55, wherein the at least one gas jet is a pressurized gas jet comprising particles of a sublimable solid material, the at least one gas jet being intended to blast the at least one surface, the particles of said sublimable solid material being sublimed after having contacted the at least one surface.

59. A method according to claim 55, wherein the at least one gas jet comprises solid carbon dioxide particles and wherein said gas is carbon dioxide.

60. A method according to claim 55, wherein the said gas jet comprises liquid nitrogen.

61. A device according to claim 1, wherein the at least one admission port is for introducing in the cavity at least one gas jet comprising a solid material.
